(19) United States
(12) Patent Application Publication
(10) Pub. No.: US 2019/0343162 A1
(43) Pub. Date: Nov. 14, 2019

(54) NUTRITIONAL FOOD PRODUCT AND RELATED METHODS

(71) Applicant: Premex, Inc., Durham, NC (US)

(72) Inventors: Alejandro YEPES, Medellín (CO); Mauricio MAYORGA, Medellín (CO); Camilo PELAEZ, Medellín (CO); Alejandro MESA, Medellín (CO)

(21) Appl. No.: 16/410,209

(22) Filed: May 13, 2019

Related U.S. Application Data
(60) Provisional application No. 62/670,954, filed on May 14, 2018.

(51) Int. Cl. A23L 33/17; A23L 15/00

(52) U.S. Cl. CPC A23L 33/17; A23L 33/16; A23V 2002/00; A23L 15/00

(57) ABSTRACT

A nutritional food product is provided that is high in egg-based protein but does not exhibit an unpleasant taste. The nutritional food product includes at least about 50% by weight of egg protein and between about 0.1% to about 15% by weight of carbohydrates.

### CROSS-REFERENCE TO RELATED APPLICATIONS

The present application claims priority to U.S. provisional application Ser. No. 62/670,954, filed May 14, 2018, the contents of which are incorporated herein in its entirety.

### BACKGROUND OF THE INVENTION

Protein is a nutrient needed by the human body for growth and maintenance. Proteins are amongst the most abundant kind of molecules in the body. Active individuals, including athletes, require elevated protein intake due to an increase in muscle mass and is needed to aid in the repair of muscles and performance as an energy source. Suggested amounts of protein typically varies between 1.6 g/kg and 1.8 g/kg.

Protein food products such as protein bars (e.g., sports bars) have become supplemental source of protein. These bars provide a source of quick energy and replenishment. The source of protein may vary but protein food products have historically relied upon soy, whey, peanuts, wheat, milk, beef or a combination thereof. The egg white makes up approximately two thirds of an egg's liquid weight and contains more than half the egg's total protein, niacin, riboflavin, chlorine, magnesium, potassium, sodium and sulfur. Egg white also contains very little carbohydrate and virtually no fat or cholesterol but high in calories. Egg proteins also have a complete amino acid profile and a high biological value, however, egg protein powdered forms are known for their unpleasant tastes.

### SUMMARY OF THE INVENTION

According to one aspect, a nutritional food product is provided that is high in egg-based protein but does not exhibit an unpleasant taste. The nutritional food product includes at least about 50% by weight of egg protein; and between about 0.1% to about 15% by weight of carbohydrates. According to one embodiment, the egg protein is in powder form. According to one embodiment, the egg protein is derived from albumen. According to one embodiment, the egg protein is derived from whole egg. According to one embodiment, the food product is fat-free. According to one embodiment, the nutritional food product is coated with a food grade composition that includes one or more nuts, grains, fruits, flavoring agents, or sweeteners, chocolate, yogurt, or peanut butter. According to one embodiment, the carbohydrate is one or more of glucose, fructose, galactose, sucrose, lactose, starch, glycogen, fiber, cellulose, beta glucan, pectin, or guar gum. According to one embodiment, the nutritional food product further includes one or more nuts, grains, fruits, flavoring agents, vitamins, minerals, or sweeteners. According to one embodiment, the nutritional food product is formulated as a bar, cookie, or wafer. According to one embodiment, the total fat content is between about 0.1% to about 30% by weight. According to one embodiment, the egg protein is derived from albumin and is present in an amount of at least about 85% by weight. According to one embodiment, the egg protein is derived from whole egg and is present in an amount of at least about 50% by weight.

According to one aspect, a process for preparing a nutritional food product is provided. The process includes the steps of mixing raw materials including an egg protein, bonding a binder to the raw materials, homogenizing the binder and raw materials to form a critical mass; and cutting the critical mass to form a final food product. According to one embodiment, the process further includes the step of heating, cooking or agitating the binder prior bonding. According to one embodiment, the egg protein is powdered. According to one embodiment, the egg protein is derived from the albumen. According to one embodiment, the egg protein is derived from whole egg. According to one embodiment, the food product is fat-free. According to one embodiment, the process includes the step of coating the food product with a food grade composition comprising one or more nuts, grains, fruits, flavoring agents, or sweeteners, chocolate, yogurt, or peanut butter.

### DESCRIPTION OF THE FIGURES

FIG. 1 provides a schematic overview of a process for preparing a nutritional food product.

### DETAILED DESCRIPTION OF THE INVENTION

The present disclosure will now be described more fully hereinafter with reference to exemplary embodiments thereof. These exemplary embodiments are described so that this disclosure will be thorough and complete, and will fully convey the scope of the disclosure to those skilled in the art. Indeed, the present disclosure may be embodied in many different forms and should not be construed as limited to the embodiments set forth herein; rather, these embodiments are provided so that this disclosure will satisfy applicable legal requirements.

The embodiments described below may assume various alternative orientations and step sequences, except where expressly specified to the contrary. Specific devices and any related processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As used in the specification, and in the appended claims, the singular forms “a”, “an”, “the”, include plural referents unless the context clearly dictates otherwise.

As used herein, the term “whole egg” refers to the combination of the egg white and egg yolk.

As used herein, the term “raw material” refers to any one or more solid components (e.g., granular, powdery and viscous components) that compose the nutritional food product provided herein.

The nutritional food product as provided herein includes a heterogeneous blend of granular, powdery and viscous products which achieve a appeasing texture and organoleptic taste response. The nutritional food product also provides a source of biologically acceptable and nutritionally required components such as, for example, protein, vitamins, minerals, and combinations thereof.

According to one embodiment, the food product as provided herein may include one or more carbohydrates to provide an energy source to a consumer. The one or more carbohydrates may include at least one glucose, fructose, galactose, sucrose, lactose, starch, glycogen, fiber, cellulose, beta glucan, pectin, guar gum, or any combination thereof.

According to one embodiment, the food product includes up to or less than about 35% by weight of total carbohydrates. According to one embodiment, the food product includes up to or less than about 25% by weight of total carbohydrates. According to one embodiment, the food product includes up to or less than about 15% by weight of total carbohydrates. According to one embodiment, the food product includes up to or less than about 10% by weight of total carbohydrates. According to one embodiment, the food product includes up to or less than about 5% by weight of total carbohydrates. According to one embodiment, the food product includes from about 0.1% to about 25% by weight of total carbohydrates. According to one embodiment, the food product includes from about 0.1% to about 15% by weight of total carbohydrates. According to one embodiment, the food product includes from about 0.1% to about 10% by weight of total carbohydrates. According to one embodiment, the food product includes from about 0.1% to about 5% by weight of total carbohydrates. According to one embodiment, the food product includes from about 4% to about 11% by weight of total carbohydrates.

According to one embodiment, the food product as provided herein may include one or more fats or fatty acids to provide long term energy to a consumer. The one or more fats may include omega-3 fatty acids, omega-6 fatty acids, omega-9 fatty acids, unsaturated fats, monosaturated fats, polysaturated fats, saturated fats, trans fats, cis fats, or any combination thereof. The one or more fats may include or be derived from cocoa butter, milk fat, vegetable oil, hydrogenated vegetable oils, hydrogenated shea oil, hydrogenated cottonseed oil, hydrogenated coconut oil, hydrogenated corn oil, hydrogenated soybean oil, hydrogenated peanut oil, caprocaprylbehenin, monounsaturated fats (e.g., olive oil and canola oil, sunflower and safflower oils), fish, marine fats, hydrogenated isomaltulose, maltitol, sorbitol, lactitol, erythritol, mannitol, xylitol, polydextrols, docosahexaenoic acid (DHA), eicosapentaenoic acid (EPA), or any combination thereof.

According to one embodiment, the food product includes up to or less than about 60 percent by weight of total fat. According to one embodiment, the food product includes up to or less than about 50 percent by weight of total fat. According to one embodiment, the food product includes up to or less than about 40 percent by weight of total fat. According to one embodiment, the food product includes up to or less than about 30 percent by weight of total fat. According to one embodiment, the food product includes up to or less than about 20 percent by weight of total fat. According to one embodiment, the food product includes up to or less than about 10 percent by weight of total fat. According to one embodiment, the food product includes up to or less than about 5 percent by weight of total fat. According to one embodiment, the food product includes up to or less than about 1 percent by weight of total fat. According to one embodiment, the food product is fat-free or has no fat. According to one embodiment, the food product includes between about 0.1 percent and about 60 percent by weight of total fat. According to one embodiment, the food product includes between about 0.1 percent and about 50 percent by weight of total fat. According to one embodiment, the food product includes between about 0.1 percent and about 40 percent by weight of total fat. According to one embodiment, the food product includes between about 0.1 percent and about 30 percent by weight of total fat. According to one embodiment, the food product is fat-free. According to one embodiment, the food product includes between about 0.1 percent and about 20 percent by weight of total fat. According to one embodiment, the food product includes between about 0.1 percent and about 10 percent by weight of total fat. According to one embodiment, the food product includes between about 0.1 percent and about 5 percent by weight of total fat. According to one embodiment, the food product includes between about 0.1 percent and about 1.0 percent by weight of total fat.

According to one embodiment, the food product includes between about 0.01 percent and about 4.0 percent by weight of Omega-3 fatty acid. According to one embodiment, the food product includes between about 0.05 percent and about 3.0 percent by weight of Omega-3 fatty acid. According to one embodiment, the food product includes between about 0.05 percent and about 2.0 percent by weight of Omega-3 fatty acid. According to one embodiment, the food product includes between about 0.05 percent and about 1.0 percent by weight of Omega-3 fatty acid. According to one embodiment, the food product includes between about 0.01 percent and about 0.5 percent by weight of Omega-3 fatty acid. According to one embodiment, the food product includes between about 0.1 percent and about 0.3 percent by weight of Omega-3 fatty acid.

According to one embodiment, the food product includes between about 0.1 percent and about 20 percent by weight of Omega-6 fatty acid. According to one embodiment, the food product includes between about 1.0 percent and about 15.0 percent by weight of Omega-6 fatty acid. According to one embodiment, the food product includes between about 2.0 percent and about 10.0 percent by weight of Omega-6 fatty acid. According to one embodiment, the food product includes between about 4.0 percent and about 6.0 percent by weight of Omega-6 fatty acid.

According to one embodiment, the food product includes between about 0.1 percent and about 30 percent by weight of Omega-9 fatty acid. According to one embodiment, the food product includes between about 1.0 percent and about 20 percent by weight of Omega-9 fatty acid. According to one embodiment, the food product includes between about 5 percent and about 15 percent by weight of Omega-9 fatty acid.

According to one embodiment, the food product includes between about 0.1 percent and about 30 percent by weight of saturated fat. According to one embodiment, the food product includes between about 1.0 percent and about 20 percent by weight of saturated fat. According to one embodiment, the food product includes between about 5.0 percent and about 15 percent by weight of saturated fat.

According to one embodiment, the food product includes between about 0.01 percent and about 10 percent by weight of trans fat. According to one embodiment, the food product includes between about 0.01 percent and about 5.0 percent by weight of trans fat. According to one embodiment, the food product includes between about 0.01 percent and about 1.0 percent by weight of trans fat.

According to one embodiment, the food product includes between about 0.01 percent and about 10 percent by weight of cis fat. According to one embodiment, the food product includes between about 0.01 percent and about 5.0 percent by weight of cis fat. According to one embodiment, the food product includes between about 0.01 percent and about 1.0 percent by weight of cis fat. According to one embodiment, the food product includes between about 0.1 percent and about 1.0 percent by weight of cis fat.

According to one embodiment, the food product as provided herein may include one or more sweeteners. The one or more sweeteners may mask, improve or alter the taste of the food product. The one or more sweeteners may include, but are not limited to, non-nutritive sweeteners, cane sugar, corn syrup, corn syrup solids, dextrose, crystalline fructose, sucrose, maltodextrin, lactose, maltose, honey, rice syrup, grain syrup, polydextrose, ologodextrin, sucralose, aspartame, saccharin, acesulfame potassium, neohesperidin dihydrochalcone, glycyrrhizin, thaumatin, alitame, stevioside, saccharin salts, aspartame, saccharine, cyclamates, sorbitol, xylitol, talin, cyclohexylsulfamates, aspartyl malonates, succanilic acids and amino acid based sweeteners, or a combination thereof.

According to one embodiment, the food product includes up to or less than about 55 percent by weight of total sweetener. According to one embodiment, the food product includes up to or less than about 45 percent by weight of total sweetener. According to one embodiment, the food product includes up to or less than about 35 percent by weight of total sweetener. According to one embodiment, the food product includes up to or less than about 25 percent by weight of total sweetener. According to one embodiment, the food product includes up to or less than about 15 percent by weight of total sweetener. According to one embodiment, the food product includes up to or less than about 5 percent by weight of total sweetener. According to one embodiment, the food product includes up to or less than about 1 percent by weight of total sweetener. According to one embodiment, the food product includes between about 0.1% and about 55 percent by weight of total sweetener. According to one embodiment, the food product includes between about 0.1% and about 45 percent by weight of total sweetener. According to one embodiment, the food product includes between about 0.1% and about 35 percent by weight of total sweetener. According to one embodiment, the food product includes between about 0.1% and about 25 percent by weight of total sweetener. According to one embodiment, the food product includes between about 0.1% and about 15 percent by weight of total sweetener. According to one embodiment, the food product includes between about 0.1% and about 5.0 percent by weight of total sweetener. According to one embodiment, the food product includes between about 0.1% and about 1.0 percent by weight of total sweetener.

According to one embodiment, the food product as provided herein may include one or more flavoring agents to mask, improve or alter the taste of the food product. The one or more flavoring agent may include, chocolate, cocoa, yogurt, vanilla extract, peanut butter, mint, cheesecake, hazelnut paste, almonds, granola, coconut, strawberry, banana, cherry, plum, raspberry, lemon, orange, lime, pineapple, blueberry, coffee, or any combination thereof.

According to one embodiment, the food product includes up to or less than about 22.5 percent by weight of total flavoring agent. According to one embodiment, the food product includes up to or less than about 12.5 percent by weight of total flavoring agent. According to one embodiment, the food product includes up to or less than about 2.5 percent by weight of total flavoring agent. According to one embodiment, the food product includes up to or less than about 1.5 percent by weight of total flavoring agent. According to one embodiment, the food product includes from about 0.1 percent to about 22.5 percent by weight of total flavoring agent. According to one embodiment, the food product includes from about 0.1 percent to about 12.5 percent by weight of total flavoring agent. According to one embodiment, the food product includes from about 0.1 percent to about 2.5 percent by weight of total flavoring agent. According to one embodiment, the food product includes from about 0.1 percent to about 1.5 percent by weight of total flavoring agent.

According to one embodiment, the food product as provided herein may include one or more dried fruit. The one or more dried fruit may include any suitable fruit appropriate for drying and inclusion in a food product. Suitable dried fruit includes dates, figs, raisins, apples, pineapples, bananas, blackberries, prunes, cranberries, cherries, or a combination thereof. According to one embodiment, the food product includes up to or less than about 22.5 percent by weight of total dried fruit. According to one embodiment, the food product includes up to or less than about 12.5 percent by weight of total dried fruit. According to one embodiment, the food product includes up to or less than about 2.5 percent by weight of total dried fruit. According to one embodiment, the food product includes between about 0.1% and about 22.5 percent by weight of total dried fruit. According to one embodiment, the food product includes between about 0.1% and about 12.5 percent by weight of total dried fruit. According to one embodiment, the food product includes between about 0.1% and about 2.5 percent by weight of total dried fruit.

According to one embodiment, the food product as provided herein may include one or more grains. The one or more grains may include wheat, barley, oats, rye, corn, soy beans, rice, sesame seeds, flax, millet, sorghum, buckwheat, quinoa, triticale, fonio, amaranth, teff, or any combination thereof. According to one embodiment, the food product includes up to or less than about 22.5 percent by weight of one or more grains. According to one embodiment, the food product includes up to or less than about 12.5 percent by weight of one or more grains. According to one embodiment, the food product includes up to or less than about 2.5 percent by weight of one or more grains. According to one embodiment, the food product includes between about 0.1% and about 22.5 percent by weight of one or more grains. According to one embodiment, the food product includes between about 0.1% and about 12.5 percent by weight of one or more grains. According to one embodiment, the food product includes between about 0.1% and about 2.5 percent by weight of one or more grains.

According to one embodiment, the food product as provided herein may include one or more nuts. The one or more nuts include peanuts, pecans, walnuts, cashews, Brazil nuts, hazelnuts, pistachios, sunflower seeds, coconuts, pine nuts, or any combination thereof. According to one embodiment, the food product includes up to or less than about 22.5 percent by weight of total nuts. According to one embodiment, the food product includes up to or less than about 12.5 percent by weight of total nuts. According to one embodiment, the food product includes up to or less than about 2.5 percent by weight of total nuts. According to one embodiment, the food product includes from about 0.1% to about 22.5 percent by weight of total nuts. According to one embodiment, the food product includes from about 0.1% to about 12.5 percent by weight of total nuts. According to one embodiment, the food product includes from about 0.1% to about 2.5 percent by weight of total nuts.

According to one embodiment, the food product as provided herein may include one or more vitamins. The one or more vitamins include any vitamin suitable for consumption. The one or more vitamins include A, B (B1, B2, B3, B5, B6, B7, B9 (folate or folic acid) or B12), C, D, E or any combination thereof. According to one embodiment, the food product includes up to or less than about 20 percent by weight of total vitamins. According to one embodiment, the food product includes up to or less than about 15 percent by weight of total vitamins. According to one embodiment, the food product includes up to or less than about 10 percent by weight of total vitamins. According to one embodiment, the food product includes up to or less than about 5 percent by weight of total vitamins. According to one embodiment, the food product includes up to or less than about 1 percent by weight of total vitamins. According to one embodiment, the food product includes up to or less than about 0.9 percent by weight of total vitamins. According to one embodiment, the food product includes from about 0.00000001% to about 20 percent by weight of total vitamins. According to one embodiment, the food product includes from about 0.00000001%% to about 15 percent by weight of total vitamins. According to one embodiment, the food product includes from about 0.00000001%% to about 10 percent by weight of total vitamins. According to one embodiment, the food product includes from about 0.00000001%% to about 5 percent by weight of total vitamins. According to one embodiment, the food product includes from about 0.00000001%% to about 0.9 percent by weight of total vitamins.

According to one embodiment, the food product as provided herein may include one or more minerals. The one or more minerals include any vitamin suitable for consumption. The one or more minerals include potassium, sodium, calcium, phosphorous, magnesium, iron, zinc, manganese, copper, iodine, chromium, molybdenum, selenium, cobalt, iodine, chromium, boron, vanadium and ascorbic acid, or any combination thereof. According to one embodiment, the food product includes up to or less than about 22.5 percent by weight of total minerals. According to one embodiment, the food product includes up to or less than about 12.5 percent by weight of total minerals. According to one embodiment, the food product includes up to or less than about 2.5 percent by weight of total minerals. According to one embodiment, the food product includes from about 0.001% to about 22.5 percent by weight of total minerals. According to one embodiment, the food product includes from about 0.001% to about 12.5 percent by weight of total minerals. According to one embodiment, the food product includes from about 0.001% to about 2.5 percent by weight of total minerals.

According to one embodiment, the food product as provided herein may include at least one protein source derived from egg protein, milk, whey protein, hydrolyzed beef protein, casein and salts thereof, peanut protein, wheat protein, leptin, vegetable protein, soy protein, or any combination thereof. According to a particular embodiment, the protein is derived from one or more of albumin (egg white), whole egg, or a combination thereof. According to such an embodiment, the egg may be harvested from a chicken, duck, pheasant, quail, goose, turkey, ostrich, pigeon, emu, fish, or any combination thereof. According to one embodiment, the albumin is formulated as a powder. According to one embodiment, the whole egg is formulated as a powder.

According to one embodiment, the food product includes up to or less than about 90 percent by weight of total protein from a source as provided herein. According to one embodiment, the food product includes up to or less than about 85 percent by weight of total protein from a source as provided herein. According to one embodiment, the food product includes up to or less than about 80 percent by weight of total protein from a source as provided herein. According to one embodiment, the food product includes up to or less than about 75 percent by weight of total protein from a source as provided herein. According to one embodiment, the food product includes up to or less than about 70 percent by weight of total protein from a source as provided herein. According to one embodiment, the food product includes up to or less than about 65 percent by weight of total protein from a source as provided herein. According to one embodiment, the food product includes up to or less than about 60 percent by weight of total protein from a source as provided herein. According to one embodiment, the food product includes up to or less than about 55 percent by weight of total protein from a source as provided herein. According to one embodiment, the food product includes up to or less than about 50 percent by weight of total protein from a source as provided herein. According to one embodiment, the food product includes up to or less than about 40 percent by weight of total protein from a source as provided herein. According to one embodiment, the food product includes up to or less than about 30 percent by weight of total protein from a source as provided herein. According to one embodiment, the food product includes up to or less than about 20 percent by weight of total protein from a source as provided herein. According to one embodiment, the food product includes up to or less than about 10 percent by weight of total protein from a source as provided herein. According to one embodiment, the food product includes from about 0.1 percent to about 90 percent by weight of total protein from a source as provided herein. According to one embodiment, the food product includes from about 0.1 percent to about 85 percent by weight of total protein from a source as provided herein. According to one embodiment, the food product includes from about 0.1 percent to about 80 percent by weight of total protein from a source as provided herein. According to one embodiment, the food product includes from about 0.1 percent to about 75 percent by weight of total protein from a source as provided herein. According to one embodiment, the food product includes from about 0.1 percent to about 70 percent by weight of total protein from a source as provided herein. According to one embodiment, the food product includes from about 0.1 percent to about 65 percent by weight of total protein from a source as provided herein. According to one embodiment, the food product includes from about 0.1 percent to about 60 percent by weight of total protein from a source as provided herein. According to one embodiment, the food product includes from about 0.1 percent to about 55 percent by weight of total protein from a source as provided herein. According to one embodiment, the food product includes from about 0.1 percent to about 50 percent by weight of total protein from a source as provided herein. According to one embodiment, the food product includes from about 0.1 percent to about 45 percent by weight of total protein from a source as provided herein. According to one embodiment, the food product includes from about 0.1 percent to about 40 percent by weight of total protein from a source as provided herein. According to one embodiment, the food product includes from about 0.1 percent to about 35 percent by weight of total protein from a source as provided herein. According to one embodiment, the food product includes from about 0.1 percent to about 30 percent by weight of total protein from a source as provided herein. According to one embodiment, the food product includes from about 0.1 percent to about 25 percent by weight of total protein from a source as provided herein. According to one embodiment, the food product includes from about 0.1 percent to about 20 percent by weight of total protein from a source as provided herein. According to one embodiment, the food product includes from about 0.1 percent to about 15 percent by weight of total protein from a source as provided herein. According to one embodiment, the food product includes from about 0.1 percent to about 10 percent by weight of total protein from a source as provided herein.

According to one embodiment, the food product as provided herein may include one or more micronutrients, macronutrients, concentrated food constituents, spices, amino acids, digestive enzymes, flavonoids, isoflavones, carotenoids, beta glucans, choline, serine and nucleotides, food stabilizers (e.g., stabilizing gums), water-binding gums, gelling agents, sodium alginate, propylene glycol alginate, calcium sulphate, gelatin, gum acacia, guar gum, gum karaya, locust bean gum, gum tragicanth, carrageenan, xanthan gum, as well as mixtures of these stabilizers, gelatin, xanthan gum, carrageenan, sodium alginate, pectin or any combination thereof.

According to one embodiment, the food product as provided herein may include one or more binders. According to one embodiment, the binder may be any food grade substance that provides support and structure to the remaining ingredients while maintaining thermal stability, viscosity and concentration (e.g., Brix degrees) which provide the required organoleptic response. According to one embodiment, the binder is sugar-based. According to one embodiment, the binder is a syrup. The syrup may include a natural sugar or artificial sweetener. According to one embodiment, the binder is one or more flavoring agents, sweeteners, chocolate, yogurt, or peanut butter. According to one embodiment, the binder composes typically between about 15% to about 65% of the total weight of the nutritional food product. According to one embodiment, the binder composes typically between about 25% to about 55% of the total weight of the nutritional food product. According to one embodiment, the binder composes typically between about 35% to about 45% of the total weight of the nutritional food product.

According to one embodiment, the food product as provided herein may include one or more fillers. According to one embodiment, the filler may be any food grade substance that are solid elements which give volume and texture to the nutritional food product. Suitable fillers include, but are not limited to, nuts, grains, fruits, flavoring agents, sweeteners, chocolate, yogurt, peanut butter, acacia, compressible sugar, gelatin, sucrose and its derivatives, maltodextrin, cellulosic polymers, such as ethylcellulose, hydroxypropylcellulose, hydroxypropylmethyl cellulose, carboxymethylcellulose sodium and methylcellulose, acrylic polymers, such as insoluble acrylate ammoniomethacrylate copolymer, polyacrylate or polymethacrylic copolymer, povidones, copovidones, polyvinylalcohols, alginic acid, sodium alginate, starch, pregelatinized starch, guar gum, polyethylene glycol, or any combination thereof.

According to one embodiment, the food product is formulated as a bar such as, for example, a nutritional bar, snack bar, or sports bar. According to one embodiment, the food product is formulated as a cookie or wafer. The food product may be stored and sold in any acceptable packaging acceptable for commercial purposes.

According to one embodiment, the food product may be covered with one or more coatings. The coating may completely envelope the food product or may be used to stripe or partially coat the food product. The coating may be made from any acceptable food grade composition. According to one embodiment, the coating includes any one or more of the nuts, grains, fruits, flavoring agents, or sweeteners as provided herein, as well as chocolate, yogurt, peanut butter, or any combination thereof.

A method of processing a whole egg to form a whole egg powder is provided. According to one embodiment, the process includes the step of pasteurizing a whole egg. The process also includes the step of weighing the whole egg in a clean and disinfected container. According to one embodiment, the process further includes the step of introducing the whole egg to a supply tank. According to one embodiment, no agitation is applied to the whole egg while in the supply tank. According to one embodiment, the process includes the step of feeding the whole egg from the supply tank and through an inlet including one or more nozzles, atomizers, or jets into a drying chamber. According to one embodiment, the at least one nozzle is a rotary disc nozzle. According to one embodiment, the whole egg is fed through the inlet at the same time at least one drying gas is introduced to the drying chamber resulting in a powder. According to one embodiment, a degree of vacuum pressure is applied to the entire spray dryer system of from about −9 to about −11 mm of water. According to one embodiment, a principal fan is utilized to generate a vacuum in the drying chamber by pulling air out of the chamber. According to one embodiment, a secondary fan is utilized to inject hot air into the drying chamber to aid in drying the egg product. According to one embodiment, the drying chamber includes one or more sensors to measure the amount of vacuum applied within the drying chamber.

The drying chamber may include one or more hammers to aid in dislodging the powder from the sides of the drying chamber. According to one embodiment, the drying gas is optionally heated prior to introduction. According to one embodiment, the inlet temperature at is typically from about 100° C. to about 325° C. According to one embodiment, the inlet temperature at is typically from about 150° C. to about 275° C. According to one embodiment, the inlet temperature at is typically from about 200° C. to about 225° C.

According to one embodiment, the process includes the step of feeding the powder from the drying chamber to a cyclone via an outlet. According to one embodiment, the outlet is typically from about 80° C. to about 110° C. According to one embodiment, the cyclone aids in collecting and separating the powder based on particle size. According to one embodiment, the process includes the steps of collecting the powder in the cyclone and introducing the powder to a sieve or mesh for consistent powder particle size. According to one embodiment, the sieve is a size 16 mesh. The powder may then be stored until introduction into a food product as provided herein.

A method of processing egg white to form an egg white powder is provided. The process also includes the step of weighing the egg white in a clean and disinfected container. According to one embodiment, the process further includes the step of introducing the egg white to a supply tank. According to one embodiment, no agitation is applied to the egg white while in the supply tank. According to one embodiment, the process includes the step of feeding the egg white from the supply tank and through an inlet including one or more nozzles, atomizers, or jets into a drying chamber. According to one embodiment, the at least one nozzle is a number 12 nozzle. According to one embodiment, the egg white is fed through the inlet at the same time at least one drying gas is introduced to the drying chamber resulting in a powder. According to one embodiment, a degree of vacuum pressure is applied to the entire spray dryer system of from about −7 mm of water. According to one embodiment, a principal fan is utilized to generate a vacuum in the drying chamber by pulling air out of the chamber. According to one embodiment, a secondary fan is utilized to inject hot air into the drying chamber to aid in drying the egg product. According to one embodiment, the drying chamber includes one or more sensors to measure the amount of vacuum applied within the drying chamber.

The drying chamber may include one or more hammers to aid in dislodging the powder from the sides of the drying chamber. According to one embodiment, the drying gas is optionally heated prior to introduction. According to one embodiment, the inlet temperature at is typically from about 190° C. to about 225° C.

According to one embodiment, the process includes the step of feeding the powder from the drying chamber to a cyclone via an outlet. According to one embodiment, the outlet is typically from about 90° C. to about 120° C. According to one embodiment, the cyclone aids in collecting and separating the powder based on particle size. According to one embodiment, the process includes the steps of collecting the powder in the cyclone and introducing the powder to a sieve or mesh for consistent powder particle size. According to one embodiment, the sieve is a size 30 mesh. The powder may then be stored until introduction into a food product as provided herein.

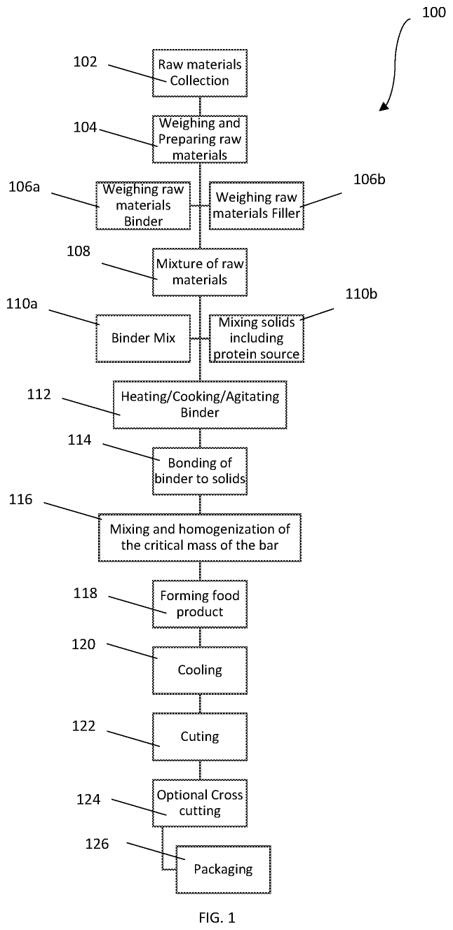

A process for preparing a nutritional food product is also provided. A particular embodiment of the processing steps 100 is set forth in FIG. 1 and reference numbers are provided herein relative to FIG. 1. According to one embodiment, the process includes the step of collecting the required raw materials 102 for inclusion in the food product. According to one embodiment, the process includes the step of weighing and preparing the raw materials 104. According to one embodiment, the process includes the step of weighing one or more binders 106a. According to one embodiment, the process includes the step of weighing one more fillers 106b.

According to one embodiment, the process includes the step of mixing the solid raw materials 108 including, but not limited to, fillers, protein sources, and other solid components as provided herein (110a, 110b). According to a particular embodiment, the protein source is an egg-based powder as provided herein. According to one embodiment, the protein source is mixed with the other raw materials thereby guaranteeing the homogeneous dispersion of the raw materials before carrying out further steps associated with preparing the food product. According to one embodiment, by carrying out the mixing step at this juncture, the moment of agglomeration reaction is instantaneous thereby resulting in a homogeneous and stable critical mass.

According to a particular embodiment, the process includes the step of cooking, heating, and/or agitating the binder 112. According to such a step, the binder may be adjusted to a desired Brix concentration. According to one embodiment, the process includes the step of bonding the binder to the solid mix which forms a critical mass 114. According to one embodiment, the process includes the step of mixing and homogenizing the critical mass of the food product with the binder 116. According to such an embodiment, the mixing and homogenizing may include introducing any one or more additional food product components as described herein.

According to one embodiment, the process includes the step of forming the food product into a desired shape 118. According to such an embodiment, the food product may be rolled and formed into any number of shapes or configurations such as, for example, a bar, wafer or cookie. According to one embodiment, the process includes the step of cooling the food product 120. According to such an embodiment, the food product may be laid out on a sheet or other acceptable horizontal surface at ambient temperature or lower temperature acceptable for allowing the food product to cool to room temperature and harden. According to one embodiment, the process includes the step of cutting the food product into a desired size based on the chosen shape or configuration 122. According to such an embodiment, the cutting step may also include cross-cutting in a perpendicular direction to form, for example, bars or wafers 124. According to one embodiment, the process includes the step of packaging the food product 126. The packing may include any information on an exterior as required under local food labeling guidelines or laws.

Although specific embodiments of the present invention are herein illustrated and described in detail, the invention is not limited thereto. The above detailed descriptions are provided as exemplary of the present invention and should not be construed as constituting any limitation of the invention. Modifications will be obvious to those skilled in the art, and all modifications that do not depart from the spirit of the invention are intended to be included with the scope of the appended claims. Having generally described the present invention, a further understanding can be obtained by reference to the examples provided herein for purposes of illustration only and are not intended to be limiting.

### Example 1

A nutritional food bar with a 100 gram base was prepared with the components set forth in Table 1. The protein source, whole egg, was formed to a powder according to the spray drying techniques described herein. The nutritional food bar was prepared according to the methods as provided herein.

TABLE 1

| | Amount of Component/ |
|---|---|
| Component | Amount of Food Product |
| Protein (whole egg powder) | 54.09 g/100 g |
| Carbohydrates | 11.09 g/100 g |
| Total Fat | 28.55 g/100 g |
| Unsaturated Fat | 18.97 g/100 g |
| Monosaturated Fat | 13.29 g/100 g |
| Polyunsaturated Fat | 5.68 g/100 g |
| Omega-3 Fatty Acid | 0.20 g/100 g |
| Omega-6 Fatty Acid | 5.48 g/100 g |
| Omega-9 Fatty Acid | 12.43 g/100 g |
| Saturated Fat | 9.00 g/100 g |
| Trans Fat | 0.05 g/100 g |
| Cis Fat | 0.51 g/100 g |
| Ash | 3.69 g/100 g |
| Calcium | 189.038 mg/100 g |
| Copper | 0.100 mg/kg |
| Iron | 7.294 mg/100 g |
| Potassium | 543.682 mg/100 g |
| Sodium | 640.877 mg/100 g |
| Zinc | 4.181 mg/100 g |
| Vitamin A | 643.90 IU/100 g |
| Vitamin E | 3.07 mg/100 g |
| Vitamin C | 0.16 mg/100 g |
| Vitamin B12 | 3.80 ug/100 g |
| Vitamin B3 | 0.89 mg/100 g |
| Selenium | 129.837 ug/100 g |
| Folic Acid | 117.69 ug/100 g |
| Pantothenic Acid | 4.18 mg/100 g |
| Phosphorous | 621.62 mg/100 g |

### Example 2

A nutritional food bar with a 100 gram base was prepared with the components set forth in Table 2. The protein source, albumin powder, was formed to a powder according to the spray drying techniques described herein. The nutritional food bar was prepared according to the methods as provided herein.

TABLE 2

| | Amount of Component/ |
|---|---|
| Component | Amount of Food Product |
| Protein (albumin powder) | 86.11 g/100 g |
| Carbohydrates | 4.04 g/100 g |
| Total Fat | 0 |
| Ash | 5.49 g/100 g |
| Calcium | 53.715 mg/100 g |
| Copper | 0.100 mg/kg |
| Iron | 0.100 mg/kg |
| Potassium | 1,194.459 mg/100 g |
| Sodium | 1,375.090 mg/100 g |
| Zinc | 0.100 mg/kg |
| Vitamin B12 | 0.47 ug/100 g |
| Vitamin B3 | 0.7 mg/100 g |
| Folic Acid | 0.05 mg/100 g |
| Pantothenic Acid | 2.67 mg/100 g |
| Phosphorous | 98.296 mg/100 g |

We claim:

1. A nutritional food product comprising
at least about 50% by weight of egg protein; and
between about 0.1% to about 15% by weight of carbohydrates.

2. The nutritional food product of claim 1, wherein the egg protein is powdered.

3. The nutritional food product of claim 1, wherein the egg protein is derived from albumen.

4. The nutritional food product of claim 1, wherein the egg protein is derived from whole egg.

5. The nutritional food product of claim 1, wherein the food product is fat-free.

6. The nutritional food product of claim 1, wherein the nutritional food product is coated with a food grade composition comprising one or more nuts, grains, fruits, flavoring agents, or sweeteners, chocolate, yogurt, or peanut butter.

7. The nutritional food product of claim 1, wherein the carbohydrate is one or more of glucose, fructose, galactose, sucrose, lactose, starch, glycogen, fiber, cellulose, beta glucan, pectin, or guar gum.

8. The nutritional food product of claim 1, further comprising one or more nuts, grains, fruits, flavoring agents, vitamins, minerals, or sweeteners.

9. The nutritional food product of claim 1, wherein the nutritional food product is formulated as a bar, cookie, or wafer.

10. The nutritional food product of claim 1, wherein the total fat content is between about 0.1% to about 30% by weight.

11. The nutritional food product of claim 1, wherein the egg protein is derived from albumin and is present in an amount of at least about 85% by weight.

12. The nutritional food product of claim 1, wherein the egg protein is derived from whole egg and is present in an amount of at least about 50% by weight.

13. A process for preparing a nutritional food product, the process comprising the steps of:
mixing raw materials including an egg protein;
bonding a binder to the raw materials;
homogenizing the binder and raw materials to form a critical mass; and
cutting the critical mass to form a final food product.

14. The process of claim 13, further comprising the step of heating, cooking or agitating the binder prior to bonding.

15. The process of claim 13, wherein the egg protein is powdered.

16. The process of claim 13, wherein the egg protein is derived from albumen.

17. The process of claim 13, wherein the egg protein is derived from whole egg.

18. The process of claim 13, wherein the food product is fat-free.

19. The process of claim 13, further comprising the step of coating the food product with a food grade composition comprising one or more nuts, grains, fruits, flavoring agents, or sweeteners, chocolate, yogurt, or peanut butter.
